(19) United States
(12) Patent Application Publication
(10) Pub. No.: US 2012/0114112 A1
(43) Pub. Date: May 10, 2012

(54) CALL CENTER WITH FEDERATED COMMUNICATIONS

(76) Inventors: Jon Rauschenberger, Chicago, IL (US); Michael Greenlee, Mississauga (CA)

(21) Appl. No.: 13/252,673

(22) Filed: Oct. 4, 2011

Related U.S. Application Data
(60) Provisional application No. 61/404,483, filed on Oct. 4, 2010.

(51) Int. Cl. H04M 3/00

(52) U.S. Cl. 379/265.02

(57) ABSTRACT

A system including an agent information system configured to expose agent information federated from a service provider; a communication interface configured to receive a call; and a computer coupled to the agent information system and the communication interface. The computer can be configured to determine an agent to receive the call in response to the agent information; and route the call to the agent.

### CROSS-REFERENCE TO RELATED APPLICATIONS

This application claims the benefit of U.S. Patent Application No. 61/404,483 filed Oct. 4, 2010, the contents of which are incorporated herein by reference.

### BACKGROUND

The present application relates to call centers, and more particularly, but not exclusively, relates to hosting call centers and providing services using federated communications.

Call centers are employed by many companies to handle customer calls regarding any number of issues related to a company's products or services. Third party hosting of call centers is often difficult because the third party and the partner (company to have a call center) are usually located at geographically different locations. Moreover, because the company and third party are at different locations, they do not share the same local area network and communications between them are not secure. Accordingly, further contributions are needed in this area of technology.

### SUMMARY

One embodiment of the present application is directed to a unique call center. Other embodiments include unique methods, systems, devices, and apparatus involving call centers. Further embodiments, forms, features, aspects, benefits, and advantages of the present application shall become apparent from the description and figures provided herewith.

### BRIEF DESCRIPTION OF THE DRAWINGS

The description herein makes reference to the accompanying drawings wherein like reference numerals refer to like parts throughout the several views, and wherein:

FIG. 1 is diagrammatic view of a system including a hosting a call center according to an embodiment;

FIG. 2 is a schematic view of an example of one of the computers of the system of FIG. 1;

FIG. 3 is a schematic block diagram of a call center system according to an embodiment;

FIG. 4 is a schematic flow diagram of a procedure for processing a call from a customer according to an embodiment;

FIG. 5 is one embodiment of an agent console;

FIG. 6 is one embodiment of an agent console;

FIG. 7 is one embodiment of an agent console;

FIG. 8 is one embodiment of an agent console;

FIG. 9 is one embodiment of an agent console;

FIG. 10 is one embodiment of an agent console;

FIG. 11 is one embodiment of a dashboard;

FIG. 12 is one embodiment of a dashboard;

FIG. 13 is one embodiment of a dashboard;

FIG. 14 is one embodiment of an admin console;

FIG. 15 is one embodiment of an admin console;

FIG. 16 is one embodiment of an admin console;

FIG. 17 is one embodiment of a web chat;

FIG. 18 is a schematic block diagram of a system according to an embodiment; and

FIG. 19 is a schematic block diagram of a system according to an embodiment.

### DETAILED DESCRIPTION OF REPRESENTATIVE EMBODIMENTS

For the purposes of promoting an understanding of the principles of the invention, reference will now be made to the embodiments illustrated in the drawings and specific language will be used to describe the same. It will nevertheless be understood that no limitation of the scope of the invention is thereby intended. Any alterations and further modifications in the described embodiments, and any further applications of the principles of the invention as described herein are contemplated as would normally occur to one skilled in the art to which the invention relates.

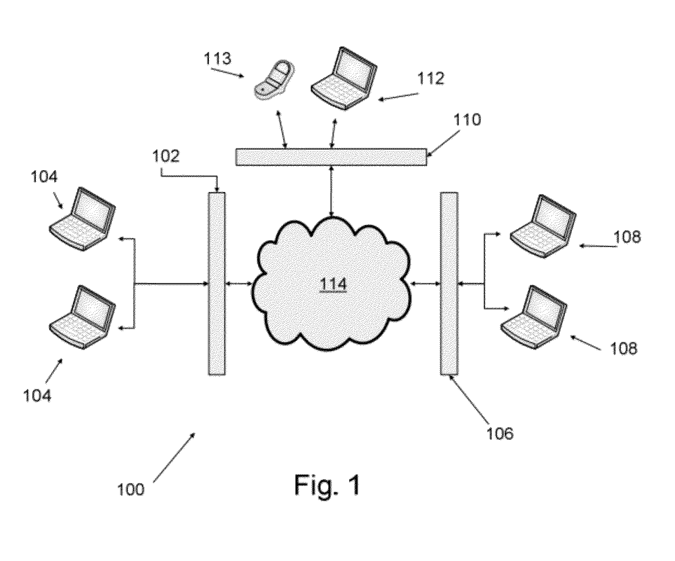

FIG. 1 shows a schematic diagram of a call center system 100. The call center system 100 may include a hosting network 102 having one or more computers 104. In one embodiment, the call center is hosted by the computers 104 on the hosting network 102. The call center system 100 may also include a partner network 106 having one or more computers 108. It is contemplated that the call center may be implemented at the hosting network 102 or at the partner network 106 or a combination of both. Generally, a hosting company will develop and implement a call center as well as host a call center for the partner company. FIG. 1 also shows a caller network 110 as well as a calling device 112 and phone 113. Generally, a caller uses calling device 112 or 113 to communicate with or call the calling center system 100. Calling device 112 may be any type of computer that allows communications including a desktop computer, laptop, smartphone, or tablet. Phone 113 may be a telephone, cell phone, or any other type of phone. FIG. 1 also shows a wide area network such as the internet but it may also include traditional land based telephone lines and cellular telephone lines and any other forms of communication.

During platform setup, one or more of the partner's telephone numbers are routed into the infrastructure in a data center. As shown in FIG. 1, the data center may be located at hosting network in a hosted implementation or at the partner's location in an on premise implementation. Generally, incoming calls on these numbers are answered by interactive voice response (IVR) system. The IVR system typically includes an attendant that walks callers through voice- or dial-tone-activated menus.

On exiting the IVR system, calls are placed in one of the skills-based queues that have been defined by the partner. While in the queue, the caller usually hears music and, optionally, one or more messages that play at configurable intervals. Meanwhile, the system monitors the availability of the agents who are configured on the platform.

Agents indicate their current availability and status (e.g., on break, after-call work, available for calls) through the presence capability of Microsoft Office Communicator as one example. If agents with the appropriate skills are available, the system routes the call immediately to the longest available agent. If not, the call is held in queue until a qualified agent becomes available.

In one embodiment, calls are delivered to agents through Office Communications Server 2007 (OCS), and agents can answer using the audio call functionality in Office Communicator. If an agent does not answer a call within a configurable time-out period, the call is bounced to the next available agent and the unresponsive agent is blocked from taking calls until that agent resets his or her presence.

The system may also provide browser-based entry points for callers to place instant message (IM) chat requests into the same skills-based queues as voice calls. Once connected, callers will interact with agent from either a browser based chat GUI provided by the system, Microsoft Office Communicator, or a third party client such as AIM or Yahoo!.

The system may also include a management console that allows supervisors to add and remove agents and reassign skills. Generally, changes should take effect immediately, so that agents can be re-skilled in real time to respond to demand. Agents may communicate with callers in a variety of ways including, but not limited to, phone, web chat, instant message, email, SMS.

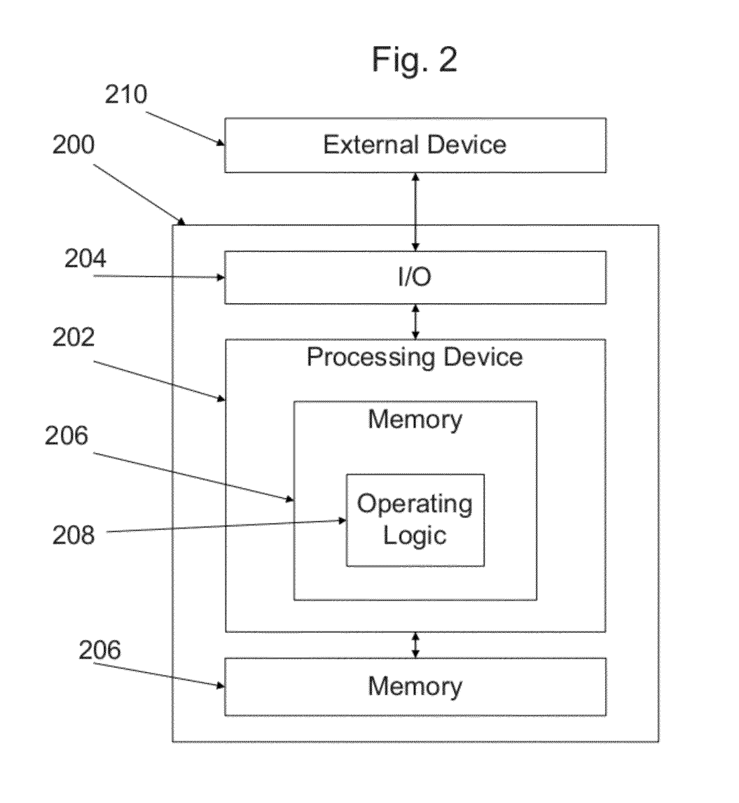

FIG. 2 is a schematic diagram of a computer 200. The computer 200 may be any of the computers 104, 108, 112 shown in FIG. 1. Computer 200 includes a processing device 202, an input/output device 204, memory 206, and operating logic 208. Furthermore, computer 200 communicates with one or more external devices 210. The input/output device 204 may be any type of device that allows the computer 200 to communicate with the external device 210. For example, the input/output device may be a network adapter, network card, or a port (e.g., a USB port, serial port, parallel port, VGA, DVI, HDMI, FireWire, CAT 5, or any other type of port). The input/output device 204 may be comprised of hardware, software, and/or firmware. It is contemplated that the input/output device 204 includes more than one of these adapters, cards, or ports. The external device 210 may be any type of device that allows data to be inputted or outputted from the computer 200. For example, the external device may be another computer, a server, a printer, a display, an alarm, an illuminated indicator, a keyboard, a mouse, a microphone, a speaker, a headset, or a touch screen display. Furthermore, it is contemplated that the external device 210 may be integrated into the computer 200. For example, the computer 200 may be a smartphone, a laptop computer, or a tablet computer in which case the display would be an external device, but the display is integrated with the computer 200 as one unit, which consistent with the general design of smartphones, laptop computers, tablet computers, and the like. It is further contemplated that there may be more than one external device in communication with the computer 200.

Processing device 202 can be of a programmable type; a dedicated, hardwired state machine; or a combination of these; and can further include multiple processors, Arithmetic-Logic Units (ALUs), Central Processing Units (CPUs), or the like. For forms of processing device 202 with multiple processing units, distributed, pipelined, and/or parallel processing can be utilized as appropriate. Processing device 202 may be dedicated to performance of just the operations described herein or may be utilized in one or more additional applications. In the depicted form, processing device 202 is of a programmable variety that executes algorithms and processes data in accordance with operating logic 208 as defined by programming instructions (such as software or firmware) stored in memory 206. Alternatively or additionally, operating logic 208 for processing device 202 is at least partially defined by hardwired logic or other hardware. Processing device 202 can be comprised of one or more components of any type suitable to process the signals received from input/output device 204 or elsewhere, and provide desired output signals. Such components may include digital circuitry, analog circuitry, or a combination of both.

Memory 206 may be of one or more types, such as a solid-state variety, electromagnetic variety, optical variety, or a combination of these forms. Furthermore, memory 206 can be volatile, nonvolatile, or a mixture of these types, and some or all of memory 206 can be of a portable variety, such as a disk, tape, memory stick, cartridge, or the like. In addition, memory 206 can store data that is manipulated by the operating logic 208 of processing device 202, such as data representative of signals received from and/or sent to input/output device 204 in addition to or in lieu of storing programming instructions defining operating logic 208, just to name one example. Operating logic 208 may be used to implement the features and services described herein.

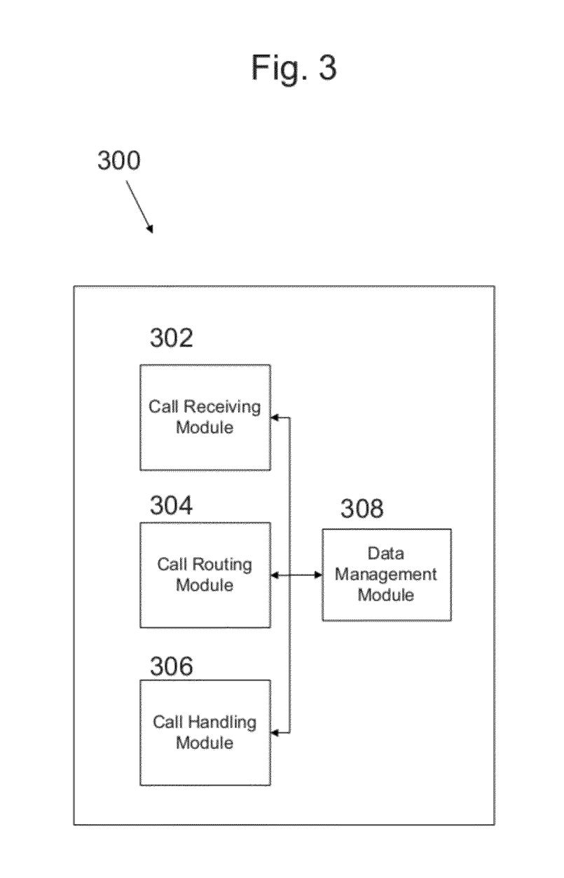

FIG. 3 shows a schematic block diagram of a call center processing system 300 according to one embodiment of the present application. The call center 300 may be implemented on the hosting network 102, on the partner network 106, or some combination of both. Furthermore, it is contemplated that in some embodiments when the call center 300 is hosted on the hosting network 102, certain equipment and/or software will be present on the partner network 106 such as a computer or phone so that calls may be transferred to agents at the partner network 106 and presence information regarding the agents may be obtained. The presence information may include whether the agent is available by any of the communication methods such as phone, web chat, instant message, email, or short message service (SMS).

The system 300 may include a call receiving module 302 that may include several features. Generally, the call receiving module 302 receive calls from customers of the partner. In one embodiment, the system can handle one or more 800 numbers that ring directly into the system 300. The call receiving module 302 may include IVR attendants to answer the calls and identify issues that the customer is calling about through a series of menus. For example, the module 302 may provide IVR attendants that are customizable and have speech or DTMF entry. In addition, the module 302 may support separate after-hours attendants that are set on a customizable schedule. The module 302 also may support text-to-speech or recorded prompts. The module 302 may also be integrated with existing systems to perform customer lookups. The module 302 also may also provide web attendants for web chat or audio callback requests. The module 302 may also have a web chat and callback request engine that can be integrated with a partner's existing website.

The system 300 may also include a call routing module 304 that receives the calls from the call receiving module and analyzes the information obtained by the IVR attendants to determine where a call should be routed. The call routing module 304 may include an automatic call distributor (ACD) that analyzes the customer's issues to determine which agent should receive the call based on the agent's skill set. The call routing module 304 routes the calls to agents at the partner network using federated communications through Microsoft's Office Communicator, for example. Federated communications generally refers to the communications that are both authenticated and secure. The call routing module 304 also monitors agent availability using presence information. The presence information may be communicated between the hosting network 102 and the partner network 106 using the Session Initiation Protocol (SIP). Using SIP, the call routing module 304 can identify the appropriate format for communications between the agent and the customer. For example, a computer at the hosting network 102 may use a SIP uniform resource identifier (URI) of an agent at the partner network 106 to identify the presence of an agent such as the agent's availability to use a phone, web chat, instant message, email, or short message service (SMS).

In another embodiment, the system 300 has a call routing module 304 that may include several features. In one embodiment, the system routes calls to agents through Microsoft Office Communicator using federation. The module 304 may implement an ACD. Routing may be based in part or in whole on the skills of a particular agent. The module 304 also supports multiple queues that are configurable and utilize separate metrics. In another embodiment, routing may utilize presence information. Agents may control their presence information through Microsoft Office Communicator or through a web control panel. In yet another embodiment, each agent has a primary and a secondary skill. The module 304 may also support overflow routing, which is triggered by service level or other KPI. The module 304 may also be configurable to enable priority routing for specific customers, calling numbers, or other call attributes. In one embodiment, the module 304 has a control panel that allows for quick and easy configuration of agents and their skills. In another embodiment, any changes to the skill of agent take immediately. The module 304 may also provide for an automatic or manual after call work period. In one embodiment, the module 304 is provides customizable “ring on no answer” handling. In another embodiment, the module 304 provides sequential (longest available agent) or broadcast (team ring) call routing. The module 304 may also provide custom music and messaging for calls in queue. In one embodiment, the module 304 provides an estimated wait time or place in queue messages. In another embodiment, the module 304 has a callback option for calls in queue.

The system 300 may also include a call handling module 306 which, among other things, provides an agent with a graphical user interface (GUI) displaying call history and caller details. The call handling module 306 may also handle transfers of calls to other agents, to voicemail, or to another queue. In addition, the call handling module 306 may also record call notes and be configurable to record the dispositions of calls. Other possible features of the call handling module 306 a browser-based agent console that provides call history and caller details. The module 306 may provide blind or “cold” transfers to other agents may be supported by the call handling module. Similarly, consultative or “warm” transfers to other agents may be supported. The call handling module 306 may also support call transfers directly to voicemail (e.g., Exchange) or transfers directly to another queue. Music may be provided while the caller is on hold. The call handling module 306 may also include an agent-initiated recording to provide the caller with certain information. The call handling module 306 may also support call notes and configurable call dispositions so that the calls may be analyzed. The call handling module 306 may also include a custom agent console having tabs that can be integrated with other systems to load other forms of caller information.

The system 300 may also include a data management module 308 that communicates with the call receiving module 302, the call routing module 304, and the call handling module 306. The data management module 308 can store information about all three of the modules as well as caller information, metrics, and reports about each call. These metrics and reports can be used at a later time by supervisors or other individuals to assess the efficiency and successfulness of the call center system 300.

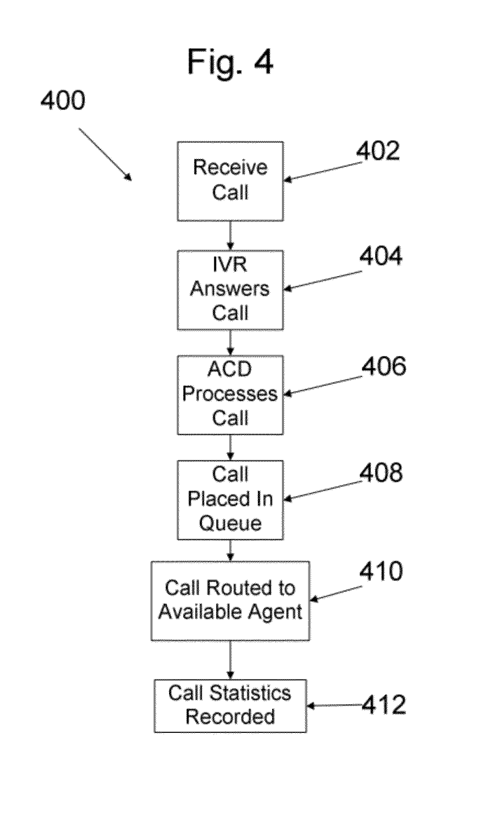

The schematic flow diagram in FIG. 4, and the related descriptions which follow, are illustrative embodiments of a technique for processing an incoming call from a customer. In operation 402, a call is received at the call center on the hosting network 102. The call is answered by an IVR in step 404. The IVR asks the caller a number of questions to identify the issues to be resolved. In operation 406, an ACD processes the call by analyzing information obtained by the IVR in operation 404. The ACD will identify an appropriate agent or agents based on the skills of the agent and the issues to be resolved. In operation 408, the ACD places the call in a queue based on the analysis performed by the ACD. In operation 410, the call is then routed to an available agent based on the agent's skills. After the call has ended, in operation 412, call statistics and call disposition may be recorded into the system 300 for later analysis.

The system 300 may also include several features related to metrics, supervision, and reporting. For example, the system 300 may include a browser-based dashboard or GUI that shows current contact center conditions. The system 300 may also include queue tiles that show metrics for each individual queue. In one embodiment, the system 300 includes service level bars with configurable thresholds. The system 300 may include an agent status view that shows current presence state of each agent. The system 300 may include an agent history screen that shows an agent's presence for the last 24 hours. In another embodiment, a silent join option for supervisors is supported. The system 300 may also include invisible call recording for agent mentoring or accountability. The system 300 may include a session inquiry screen for searching call notes, recordings, or call details. The system 300 may provide rich metric data with several built-in reports. In one embodiment, up to five custom reports are included with each implementation.

The system 300 may include support for a variety of metrics to track the efficiency and the status of the call center. For example, the metrics supported by the system 300 may include, but are not limited to, average handle time (AHT), average speed of answer (ASA), abandon rate (ABA), average time to abandon (ATA), max queue delay, after call work time, talk time, agent login time, agent idle time, agent off-desk time, agent handled call count, agent missed call count, occupancy rate, and service level (configurable). The metrics may be available in hourly and/or daily averages and by queue or by agent. It is contemplated that other metrics may be provided.

The system 300 may provide a number of services or features including, but not limited to, after-hours or non-business-day attendant with different messaging, callback option while on hold; the caller receives a call back from the platform when a qualified agent becomes available, bypass numbers to skip the IVR and enter a queue directly, KPI-based overflow to “backup” agents, higher and lower priority skills per agent, priority call routing by caller ID, automatic or manually-activated after call work period, callback requests placed by website.

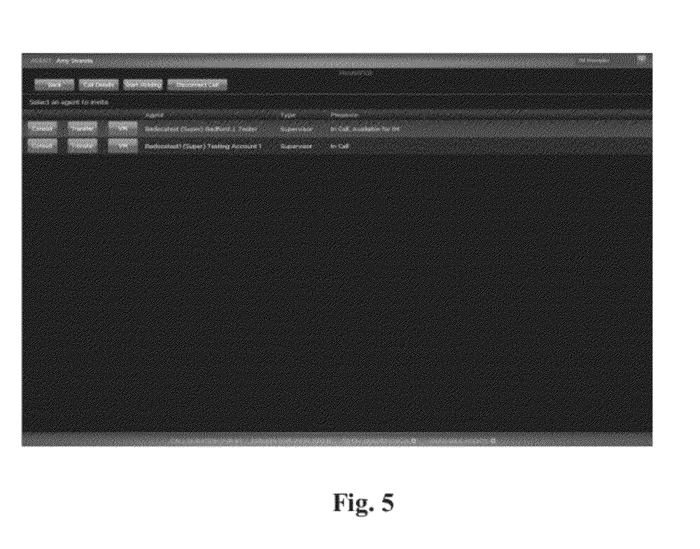

In one embodiment, the system 300 includes an agent console. FIGS. 5-10 show various services or features that may implemented in the agent console. The agent console assists call agents in the handling of calls efficiently to meet customers' needs. The agent console may be implemented as a web-browser based application that provides contextual information about calls along with call control features.

FIG. 5 shows call controls that may be included on the agent console. In FIG. 5, the presence information of agents is displayed.

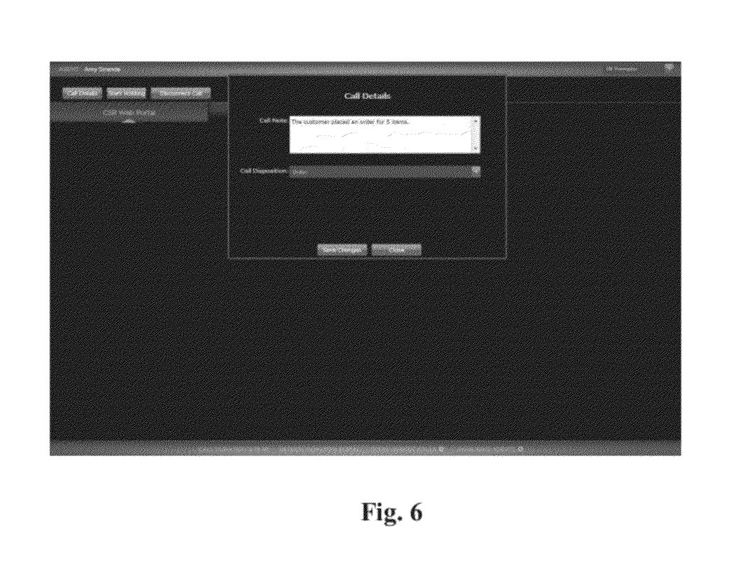

FIG. 6 shows how a call disposition may be captured by the agent console. The agent console includes a box for the agent to insert text and a drop down menu of various dispositions for the call.

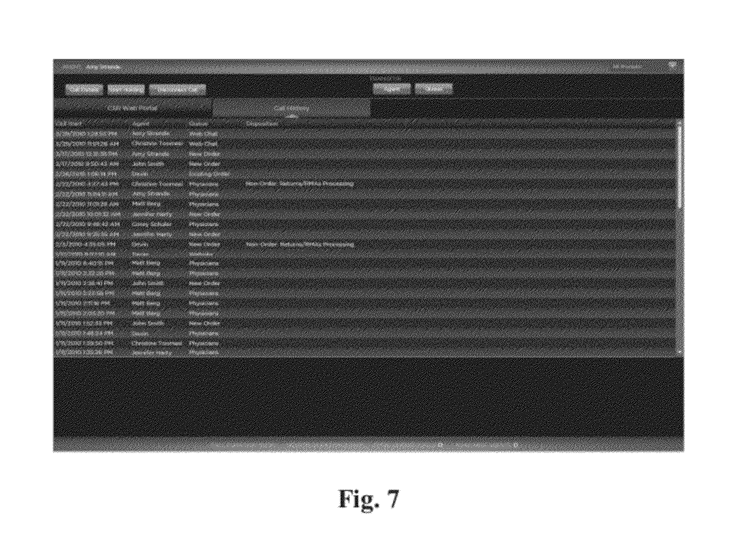

FIG. 7 shows a call history feature on the agent console. The call history feature displays the date and time of the call, the agent, the queue, and the disposition.

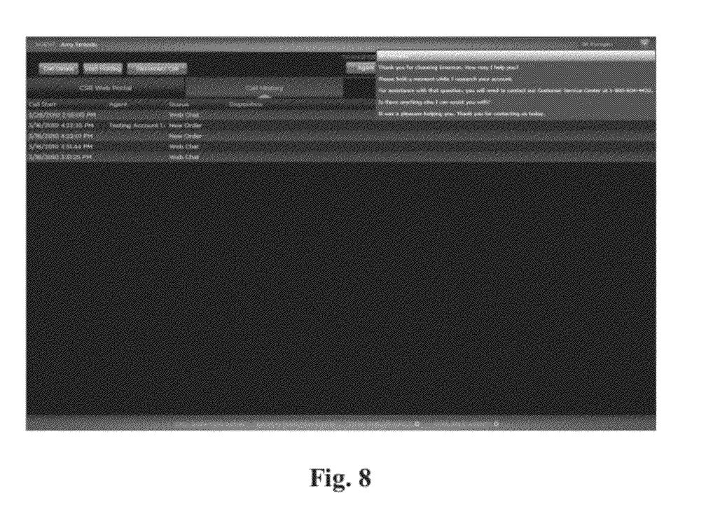

FIG. 8 shows how instant messaging (IM) prompts may be used in the agent console. For example, the agent may select one of the predefined IM prompts to send to the customer. This may save time since the agent would not need to type out every IM message.

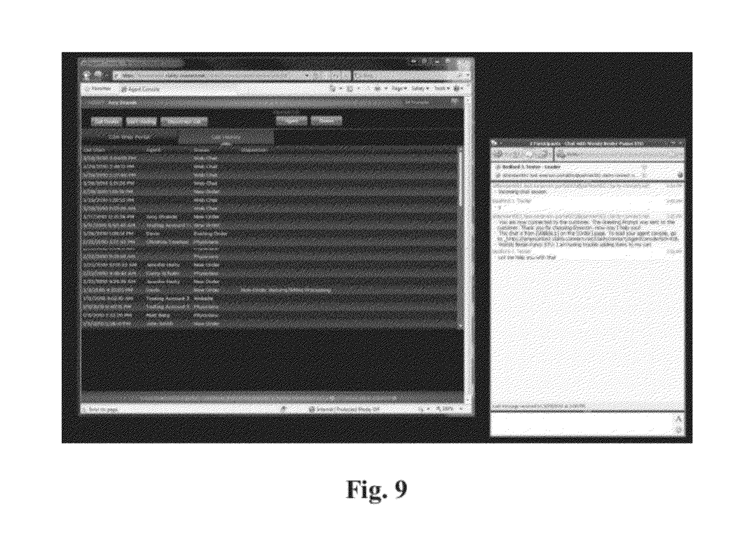

FIG. 9 shows an agent console with a communicator tab open. This allows the agent to communicate with the customer rather than using a phone.

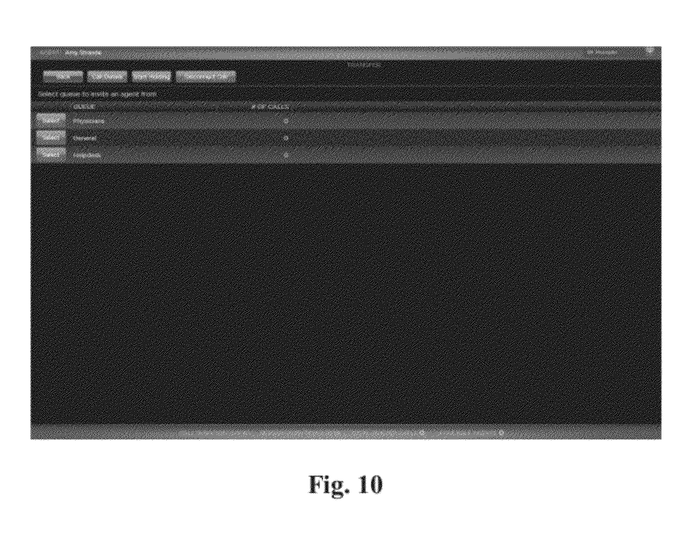

FIG. 10 shows how an agent can transfer a call to another queue. In FIG. 10, the agent can select the queue by clicking the “Select” button.

In one example, the agent console is built using Microsoft Silverlight. Once the Silverlight runtime is installed on a call agent's machine, no downloads or installations are required. Once the agent has logged in, any incoming call to that agent causes the agent console to populate with previous call history for the caller, if identified, as well as metrics for the call.

Among other features, the agent console allows agents to enter notes or select a disposition describing the subject of the call. Buttons on the top of the agent console give the agent the ability to place a call on hold, transfer it to another agent, or return it to a queue. The agent console has a modular interface which allows custom-built add-ins to be implemented to address any other needs for contextual information.

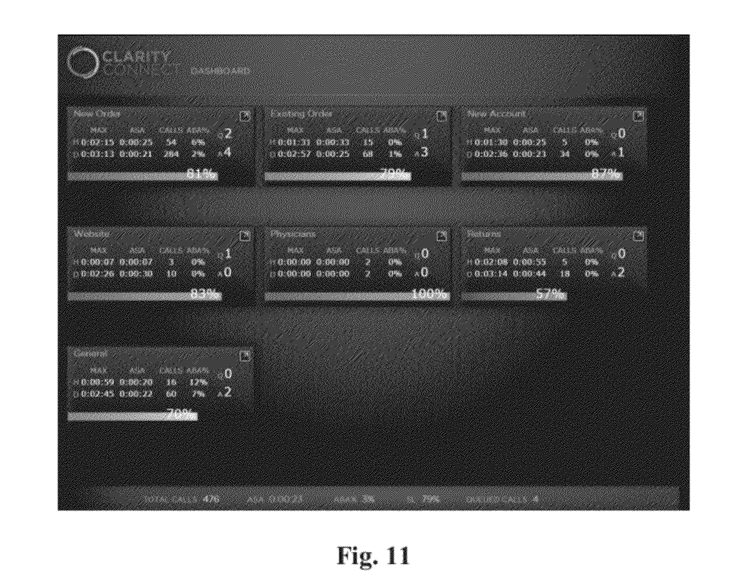

The system 300 may also include a dashboard that provides real-time visibility into metrics and agent status. FIGS. 11-13 show various features that may be implemented in a dashboard. FIG. 11, for example, shows a dashboard with the various queues displayed. The dashboard provides supervisors with a window into the current state of the processes they are tasked with managing. One or more queues may be displayed as tiles on the dashboard with a number of call-related metrics. Each queue tile shows, among other information, average speed of answer (ASA), max queue delay, call count, abandon rate for the current hour, and abandon rate for the current day. The current number of active calls and queued calls may also be displayed on each queue tile. The dashboard may also include a queue health bar to track a partner-defined KPI, often a service level, changing colors to indicate whether the queue health is lower or higher.

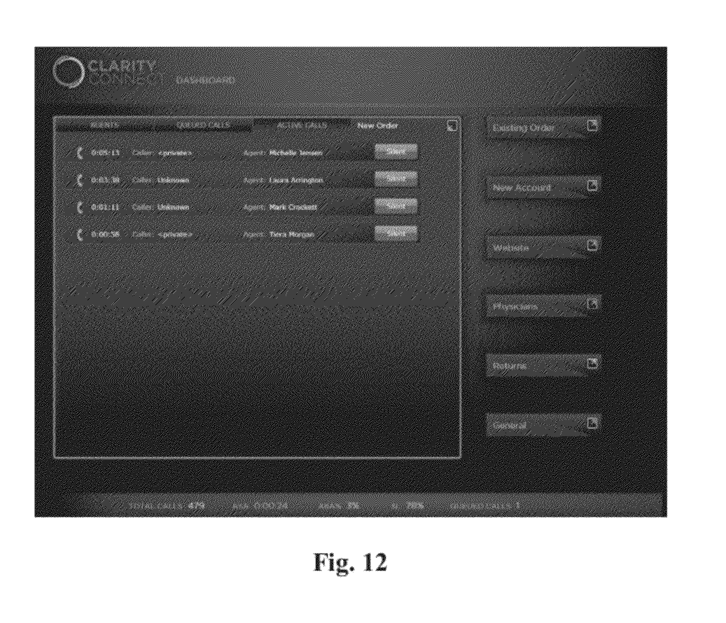

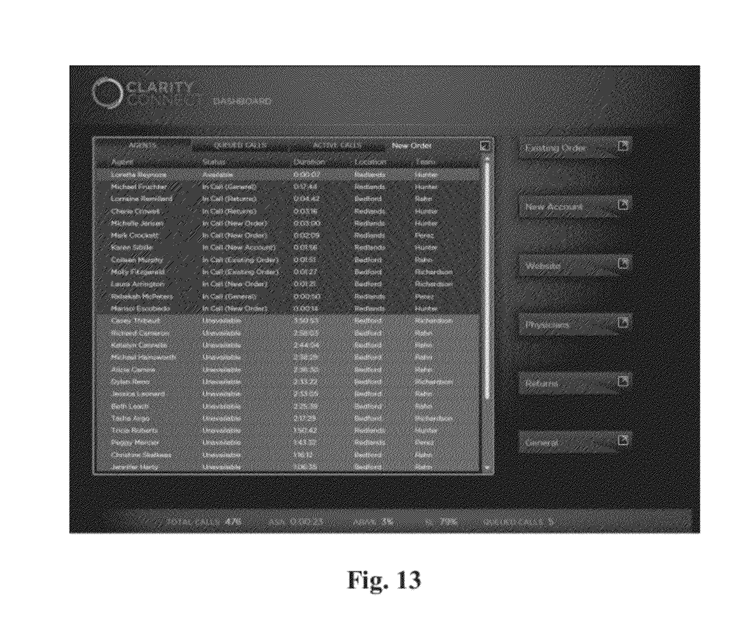

FIG. 12 shows another embodiment of a dashboard in which a supervisor can monitor agents, queued calls, active calls, or new orders. The supervisor is able to see the various calls, which agent is handling them, and the length of the calls. FIG. 13 shows another example of a dashboard with the New Orders tab selected. In the New Orders tab, the supervisor can see agent's name, status, duration of the call, location, and team.

The information provided by the dashboard allows a supervisor, for example, to see how well the call center is performing and where reinforcements can be most effectively placed. The queue tile can be expanded to display individual active and queued calls, complete with caller ID information, agent information, and how long the call has been queued or active. In one embodiment, a supervisor can join a call as a silent participant to monitor an agent's performance. The dashboard may also provide an agent status view, which shows the current availability and activity of each agent in the call center.

The system 300 may also include several built-in reports or features. For example, the system 300 may include a historical queue report that details call center metrics per queue or overall. The system 300 may include interval reports, which break down various metrics to show call center performance at intervals over the course of a day. In another example, the system 300 may include an agent history report, which shows agent performance and time usage over one or more days. The system 300 may also include a session inquiry feature on the management console, which offers the ability to see details on a specific session, including, but not limited to, the caller, the responding agent, notes, and other information. In yet another example, the system 300 may include a call recording feature in which calls may be recorded for later review or downloading.

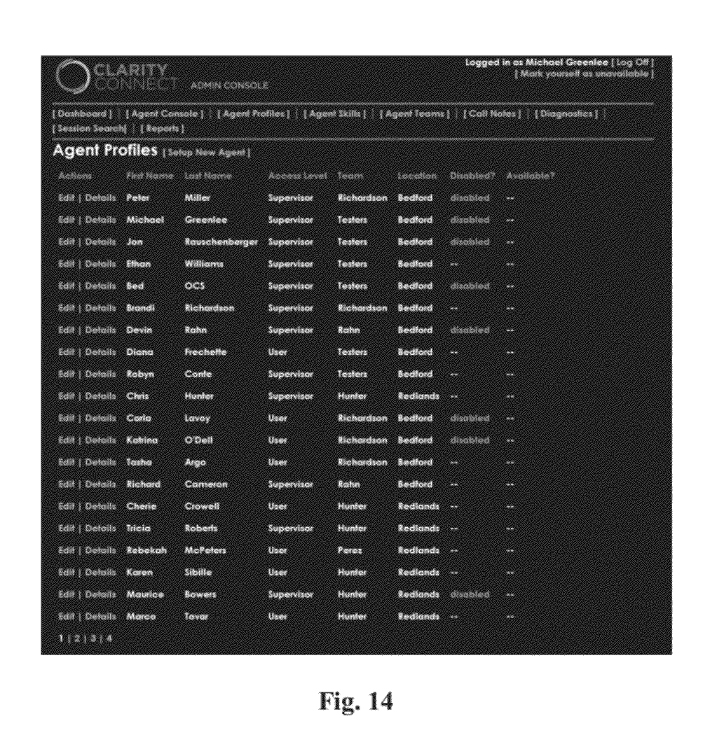

FIGS. 14-16 show various features that may be implemented in an admin console. Generally, the admin console allows a person to monitor and manage all persons using the system including, but not limited to, supervisors, agents, or users.

FIG. 14 shows, for example, agent profiles including the agent's name, access level, team, location, whether he or she is disabled, and availability.

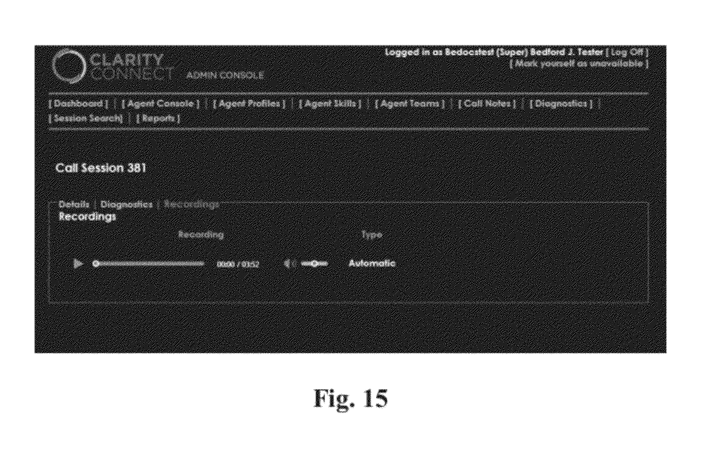

FIG. 15 shows one embodiment of an admin console in which recordings can be reviewed for quality assurance and the like.

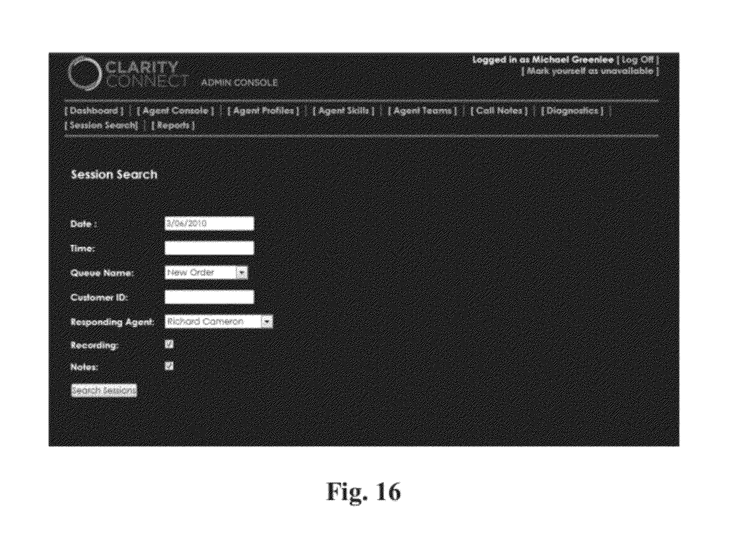

FIG. 16 shows another embodiment of an admin console showing how to search for a session. Locating may desirable to for a variety of reasons including to make sure the customer's needs were met or to review the quality of an agent's work, for example.

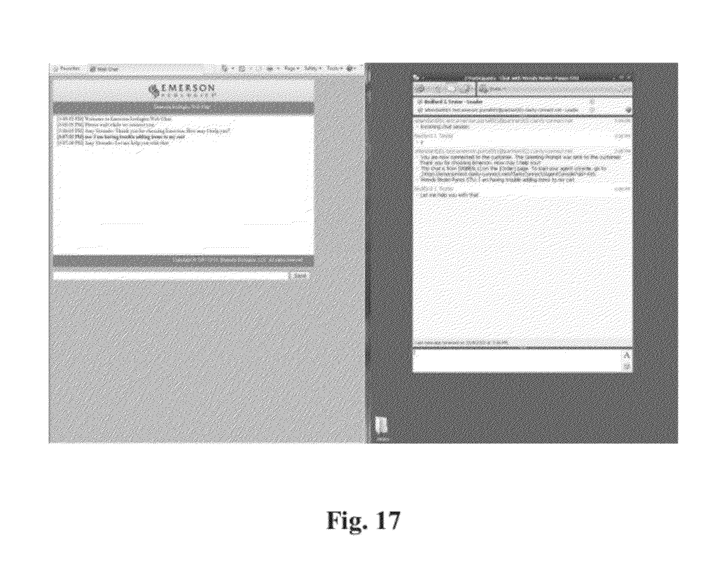

FIG. 17 shows one embodiment of a web chat between an agent and a customer. For some customers, engaging in a web chat may be more desirable than calling an agent at a call center using a phone.

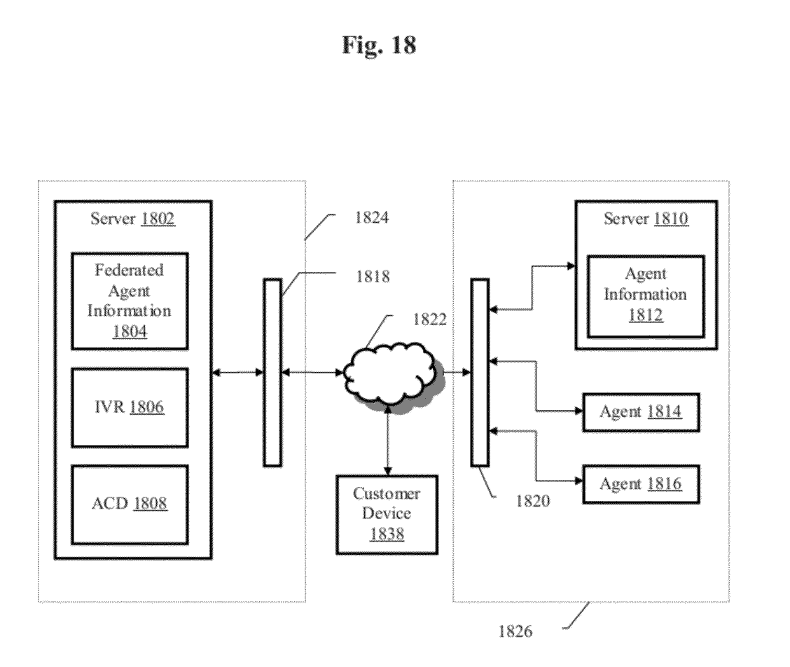

FIG. 18 is a schematic block diagram of a system according to an embodiment. In an embodiment, a service provider can operate a call center. Agents at the call center can respond to customer inquiries. Agents 1814 and 1816 can represent the agents of the call center. A server 1810 can be configured to maintain agent information 1812. Such agent information 1812 can include authentication information, contact information, presence information, agent skills, device capabilities, or the like. The server 1810 can be implemented similar to the computer 200 described above.

The agent information 1812 can be part of an authentication system, registrar, domain controller, or the like for agents of the call center. For example, the server 1810 can be a domain controller, an IM server, a SIP registrar, VoIP server, or the like. An agent's 1814 softphone, email client, IM client, etc. can be authenticated by the server 1810. Although a single server 1810 is described, such functionality can be provided by a distributed system, multiple individual servers, a combination of such systems, or the like.

In an embodiment, the agents 1814 and 1816 are coupled to the server 1810 through network 1820. The server 1810 can be the authority for the domain 1826 including the agents 1814 and 1816. Accordingly, internal to the domain 1826, identities of agents 1814 and 1816 can be authenticated, communications can be established, or the like.

In an embodiment, the agent information 1812 can be federated outside of the domain 1826. For example, server 1802 can include federated agent information 1804. That is, the server 1802 can implement an agent information system configured to expose agent information 1812 federated from the server 1810. The agent information 1812 can, but need not be stored on the server 1802. The agent information 1812 can be accessible through the server 1802. For example, a communications link can be established between server 1802 and server 1810, between federation servers of the respective domains 1824 and 1826, or the like.

In an embodiment, federated communications is a mechanism by which systems can establish secure and authenticated connections that allow users and applications connected to each system freely communicate with users connected to other systems. The connections can be established using either industry standard communication protocols such as SIP, Extensible Messaging and Presence Protocol (XMPP), or the like. In addition, the connections can be established by vendor specific protocols such as protocols used by Microsoft Lync, AOL, or the like.

In an embodiment, federated communications enable use cases including adding users from other organizations to your Contacts list, sending instant messages to your federated contacts, inviting contacts to audio calls, video calls, or conferences, exchanging presence information, escalate person-to-person instant messages to multi-person conferences, or the like. Any variety of communication, authentication for such communication, or the like can be federated.

The server 1802 can be coupled to a network 1818. The network 1818 can form a domain including the server 1802. The networks 1818 and 1820 can be coupled to a wide area network 1822, such as the internet. Through federation of the agent information 1812 at the server 1802, presence, skills, capabilities, devices, or the like of agents 1814 and 1816 can be exposed at the server 1802.

In an embodiment, a customer device 1838 can be coupled to the network 1822. For example, the customer device 1838 can be a VoIP phone, IM client, telephone, wireless telephone, email client, or the like. A call can be placed by the customer device 1838. In particular, a call can be placed that is associated with a particular service provider. In this example the service provider is the service provider associated with the agents 1814 and 1816 of domain 1826.

As used herein, a call is not limited to any one type or a single type of communication. For example, a call can be a telephone call, an IM chat, an email, a videoconference, or the like. That is, a user can contact the service provider through a variety of communication techniques each of which or a combination of can be referred to as a call.

Rather than routing the call to the network 1820 of the service provider, the call can be routed to network 1818 and the server 1802. That is, the call can be routed to a server 1802 where the federated agent information 1804 is available. The server 1802 can include a communication interface configured to receive the call. For example, a network interface coupling the server 1802 to the network 1818 can be such an interface.

The server 1802 can be configured to determine an agent to receive the call in response to the federated agent information 1804. In this example, the server 1802 can be configured to select one or more of the agents 1814 and 1816 to receive the call. In particular, as described above, the server 1802 can use agent information such as presence, device capabilities, agent skills, or the like to determine an agent to receive the call; however, in contrast to directly contacting the service provider, the federated agent information 1804 can be used to make the determination.

Once the agent to receive the call is determined, the call can be routed to the agent. The call setup can proceed between the customer device 1838 and the agent 1814, for example. The server 1802 can, but need not be involved as a proxy, gateway, or the like.

In an embodiment, at least one of agent voice information and agent video information federated from the service provider can be exposed in the federated agent information 1804. That is, information related to voice and/or video calls, setup information for such calls, can be federated from the server 1810. Thus, communication techniques beyond presence and IM can be used in routing the call.

As described above, an IVR system 1806 and/or an ACD 1808 can be used to process incoming calls. Such systems can be referred to as automated systems; however, such systems could be implemented with a live operator. In an embodiment, the server 1802 includes an IVR system 1806 and an ACD 1808. The IVR system 1806 can be configured to answer the call and obtain information associated with the call from the customer. Such information can be used by the ACD 1808 to route the call. For example, the call information from the IVR system 1806 can be used to filter agents, select a particular queue, or the like.

Although routing the call to an agent has been described, such routing can, but need not be directly to the agent. As described above, a queue can be used. Thus, routing a call to an agent can include routing the call to a queue associated with one or more agents.

Although the federated agent information 1804, IVR system 1806, and ACD 1808 have been described as part of server 1802, such information and/or functionality can be distributed as desired. For example, the federated agent information 1804 can be exposed to the server 1802 through a federation server (not illustrated) coupled to the network 1818. The federation server can be configured to federate the agent information 1812 of server 1810. Similarly, the IVR system 1806, ACD 1808, or the like can be separately implemented. Any distribution of such functionality in the domain 1824 can be used as desired.

Although federated agent information 1804 has been described as being used to route a call from a customer device 1838 to an agent 1814, the federated agent information 1804 can be used to modify the call to include a second agent 1816. For example, as described above, a supervisor may be included in a call. The call can be transferred to the supervisor, the supervisor can monitor the call, or the like. The federated agent information 1804 can be used to determine such an agent 1816 to act as a supervisor to modify the call.

For example, a request for a supervisor from the agent 1814 can be routed to the server 1802. Using the federated agent information 1804 exposed at the server 1802, a supervisor can be selected. In this example, agent 1816 was selected. Although the selected agent 1816 was in the same domain 1826 as agent 1814, the request from the agent 1814 can still be routed to the server 1802. As will be described in further detail, other agents of the service provider may be in different domains. The routing of the request to the server 1802 can allow for agents in other domains to respond.

In an embodiment, the domain 1824 including the server 1802 with the federation agent information 1804 can be outside of any domain of a service provider. That is, because of the federation of the agent information 1812, the service provider can, but need not maintain control over the domain 1824. Thus, the domain 1824 can be operated by a third party. Furthermore, the federated agent information 1804 can be federated from multiple service providers. Calls for the service providers can be routed to the server 1802 which then, due to the federation, can determine which agent of the appropriate service provider can receive the call.

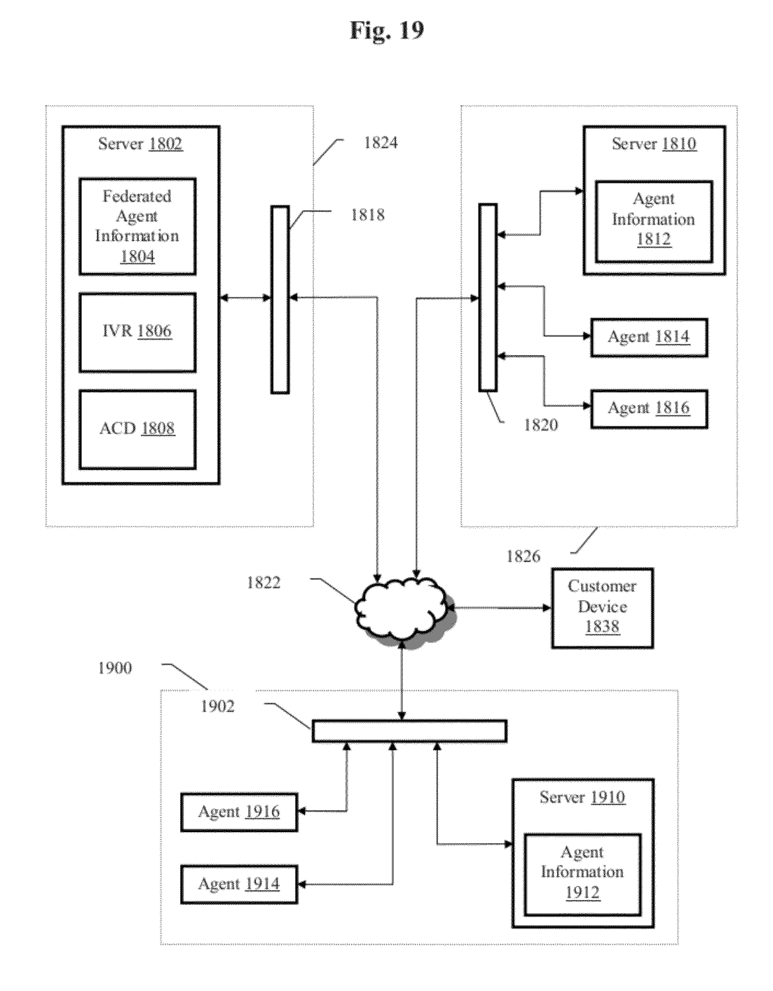

FIG. 19 is a schematic block diagram of a system according to an embodiment. In this embodiment, networks 1818 and 1820, the associated components, and customer device 1838 are coupled to the network 1822 similar to FIG. 18. However, a third network 1902 of domain 1900 including agents 1914 and 1916, and server 1910 with agent information 1912.

As described above, agent information from multiple service providers can be federated at the server 1802. Domain 1900 can represent a domain of a service provider different from that of domain 1826. Customer calls from customer device 1838 for both service providers can be routed to the server 1802. The server 1802 can use the agent information federated from the appropriate service provider to route the call from the customer device 1838.

In another embodiment, domain 1900 can be part of a single service provider. For example, a service provider may acquire another service provider, establish a new facility, update equipment at an existing facility, or the like. As a result, the domain 1900 can have its own domain controller, authentication, communication servers, or the like. That is, in this example, the server 1910 can have its own agent information 1912 separate from the agent information 1812 of server 1810.

However, due to the federation of both the agent information 1812 and agent information 1912 in the federated agent information 1804, calls can be routed appropriately from customer device 1838. Furthermore, as described above, other routing and/or modification of a call can cross domain boundaries. As described above, a supervisor can be included in a call. The supervisor could be agent 1916 in domain 1900 while the original agent is agent 1814 in domain 1826. The federated agent information 1804 can be used to establish such communications.

An embodiment includes a computer-readable medium storing computer-readable code. When executed on a computer, the computer-readable code can cause the computer to perform any combination or all of the functionality described above. A computer can include the computer 200 described above, a combination of such computers 200, or the like.

Any experimental (including simulation) results are exemplary only and are not intended to restrict any inventive aspects of the present application. Any theory, mechanism of operation, proof, or finding stated herein is meant to further enhance understanding of the present application and is not intended to make the present application in any way dependent upon such theory, mechanism of operation, proof, or finding. Simulations of the type set forth herein are recognized by those skilled in the art to demonstrate that methods, systems, apparatus, and devices, are suitable for their intended purpose. It should be understood that while the use of the word preferable, preferably or preferred in the description above indicates that the feature so described may be more desirable, it nonetheless may not be necessary and embodiments lacking the same may be contemplated as within the scope of the invention, that scope being defined by the claims that follow. In reading the claims it is intended that when words such as “a,” “an,” “at least one,” “at least a portion” are used there is no intention to limit the claim to only one item unless specifically stated to the contrary in the claim. Further, when the language “at least a portion” and/or “a portion” is used the item may include a portion and/or the entire item unless specifically stated to the contrary. While the invention has been illustrated and described in detail in the drawings and foregoing description, the same is to be considered as illustrative and not restrictive in character, it being understood that only the selected embodiments have been shown and described and that all changes, modifications and equivalents that come within the spirit of the invention as defined herein or by any claims that follow are desired to be protected.

What is claimed is:

1. A method, comprising:
receiving a call associated with a service provider;
accessing agent information federated from a server of the service provider;
determining an agent to receive the call in response to the agent information; and
routing the call to the agent.

2. The method of claim 1, wherein accessing the agent information comprises accessing agent information federated from a plurality of servers of the service provider in a plurality of domains.

3. The method of claim 1, further comprising:
answering the call with an automated system;
receiving call information associated with the call through the automated system; and
determining the agent to receive the call in response to the agent information and the call information.

4. The method of claim 1, wherein accessing the agent information comprises accessing at least one of agent voice information and agent video information federated from the server of the service provider.

5. The method of claim 1, wherein accessing the agent information comprises accessing the agent information in a server outside of any domain of the service provider.

6. The method of claim 1, the agent to receive the call referred to as a first agent, the method further comprising:
accessing second agent information federated from the server of the service provider in response to the first agent;
determining a second agent in response to the second agent information; and
modifying the call to include the second agent.

7. A system, comprising:
an agent information system configured to expose agent information federated from a service provider;
a communication interface configured to receive a call; and
a computer coupled to the agent information system and the communication interface, the computer configured to:
determine an agent to receive the call in response to the agent information; and
route the call to the agent.

8. The system of claim 7, wherein the agent information system is configured to expose agent information federated from a plurality of domains of the service provider.

9. The system of claim 7, further comprising:
an automated system configured to answer the call;
wherein the computer is further configured to:
receive call information associated with the call through the automated system; and
determine the agent to receive the call in response to the agent information and the call information.

10. The system of claim 7, wherein the agent information system is configured to expose at least one of agent voice information and agent video information federated from the service provider.

11. The system of claim 7, wherein the computer is within a domain outside of any domain of the service provider.

12. The system of claim 7, the agent to receive the call referred to as a first agent, wherein:
the agent information system is configured to expose second agent information federated from the server of the service provider in response to the first agent; and
the computer is further configured to:
determine a second agent in response to the second agent information; and
modify the call to include the second agent.

13. The system of claim 7, the service provider referred to as a first service provider, wherein the agent information system is configured to expose agent information federated from a second service provider.

14. The system of claim 13, wherein the computer is further configured to:
select a service provider in response to the call; and
determine the agent to receive the call in response to the agent information associated with the selected service provider exposed by the agent information system.

15. A computer-readable medium storing computer-readable code that when executed on a computer, causes the computer to:
receive a call associated with a service provider;
access agent information federated from a server of the service provider;
determine an agent to receive the call in response to the agent information; and
route the call to the agent.

16. The computer-readable medium of claim 15, further storing computer-readable code that when executed on the computer, causes the computer to:
access agent information federated from a plurality of servers of the service provider in a plurality of domains.

17. The computer-readable medium of claim 15, further storing computer-readable code that when executed on the computer, causes the computer to:
answer the call with an automated system;
receive call information associated with the call through the automated system; and
determine the agent to receive the call in response to the agent information and the call information.

18. The computer-readable medium of claim 15, further storing computer-readable code that when executed on the computer, causes the computer to:
access at least one of agent voice information and agent video information federated from the server of the service provider.

19. The computer-readable medium of claim 15, further storing computer-readable code that when executed on the computer, causes the computer to:
access the agent information in a server outside of any domain of the service provider.

20. The computer-readable medium of claim 13, the agent to receive the call referred to as a first agent, the computer-readable medium further storing computer-readable code that when executed on the computer, causes the computer to:
access second agent information federated from the server of the service provider in response to the first agent;
determine a second agent in response to the second agent information; and
modify the call to include the second agent.

21. A method, comprising:
receiving a call associated with a service provider;
accessing agent information from a first server of the service provider in a first domain through a second server in a second domain;
determining an agent to receive the call in response to the agent information; and
routing the call to the agent;
wherein the agent information is authenticated by the first server.

22. The method of claim 21, wherein:
accessing the agent information comprises accessing agent information from a plurality of servers of the service provider in a plurality of domains through the a second server in the second domain; and
each of the plurality of servers authenticates the agent information associated with a corresponding one of the domains.

23. The method of claim 21, wherein accessing the agent information comprises accessing the agent information in a server outside of any domain of the service provider.
